(19) United States
(12) Patent Application Publication
(10) Pub. No.: US 2007/0197373 A1
(43) Pub. Date: Aug. 23, 2007

(54) Zirconia core particles coated with ceria particles, production process thereof and exhaust gas purifying catalyst

(75) Inventors: Masahide Miura, Shizuoka (JP); Oji Kuno, Aichi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Aichi (JP)

(21) Appl. No.: 10/591,797

(22) PCT Filed: Apr. 27, 2005
(86) PCT No.: PCT/JP05/08464

§ 371 Date: Sep. 6, 2006

(51) Int. Cl. B01J 21/00

(52) U.S. Cl. 502/100

(57) ABSTRACT

The present invention provides a metal oxide particle for a catalyst support comprising multiple species of metal oxides and capable of satisfactorily exerting the properties of the respective metal oxides, and also provide a production process therefor and an exhaust gas purifying catalyst obtained from this metal oxide particle. A metal oxide particle of the present invention comprises a core part 1 relatively rich in a first metal oxide and a surface layer 2 relatively rich in a second metal oxide, the core part and the surface layer each comprising a plurality of primary particles (1a, 2a), and the primary particle diameter of the second metal oxide being smaller than the primary particle diameter of the first metal oxide.

### TECHNICAL FIELD

The present invention relates to a metal oxide particle, a production process thereof, and an exhaust gas purifying catalyst produced from the metal oxide particle.

### RELATED ART

The exhaust gas from internal combustion engines, such as automobile engines, contains nitrogen oxide (NOₓ), carbon monoxide (CO), hydrocarbon (HC) and the like. These substances can be purified by using an exhaust gas purifying catalyst capable of oxidizing CO and HC and, at the same time, reducing NOₓ. As for representative exhaust gas purifying catalysts, three-way catalysts where a noble metal such as platinum (Pt), rhodium (Rh) and palladium (Pd) is supported on a porous metal oxide support such as γ-alumina are known.

The metal oxide support may be formed of various materials, but in order to obtain a large surface area, alumina (Al₂O₃) has been heretofore generally used. However, in recent years, for accelerating purification of the exhaust gas by using chemical properties of the support, it has been proposed to use various other materials such as ceria (CeO₂), zirconia (ZrO₂) and titanium (TiO₂) in combination with or not in combination with alumina.

For example, in order to alleviate the fluctuation of oxygen concentration in the exhaust gas and thereby increase the exhaust gas purifying ability of the three-way catalyst, a material having an oxygen storage capacity (OSC) of storing oxygen when the oxygen concentration in the exhaust gas is high, and releasing oxygen when the oxygen concentration in the exhaust gas is low, is used as a support of the exhaust gas purifying catalyst. A representative material having OSC is ceria.

In order to allow for efficient progress of oxidation of CO and HC and reduction of NOₓ by the activity of the three-way catalyst, the air-fuel ratio in the internal combustion engine must be a theoretical air-fuel ratio (stoichiometric air-fuel ratio). Therefore, the fluctuation of oxygen concentration in the exhaust gas is preferably alleviated to maintain the oxygen concentration in the vicinity of the theoretical air-fuel ratio, so that the three-way catalyst can exert its exhaust gas purifying ability. Furthermore, according to recent studies, it has been found that ceria not only has OSC but also, by virtue of its strong affinity for noble metal, particularly platinum, can prevent particle growth (sintering) of the noble metal supported thereon.

Therefore, ceria has preferred properties for use in an exhaust gas purifying catalyst, but sometimes fails in satisfying heat resistance required in such usage. Accordingly, a method for increasing the heat resistance of ceria by forming a solid solution of ceria and zirconia has been developed (see, for example, Japanese Unexamined Patent Publication (Kokai) No. 10-194742 and 6-279027).

Further, Japanese Unexamined Patent Publication (Kokai) No. 2004-74138 discloses a ceria-based particle used as a catalyst support wherein the outer part of the particle is rich in ceria and inner part of the particle is poor in ceria. The reference states that the ceria-based particle suppresses particle growth of the noble metal supported thereon due to the outer part of the particle rich in ceria, and provides little capacity for oxygen storing and releasing due to the inner part of the particle poor in ceria. The ceria-based particle is produced by a method of impregnating ZrO₂ power or AlO₂ powder with aqueous cerium nitrate solution, and firing it; a method of precipitating ZrO₂ precursor from zirconium oxynitrate solution, adding aqueous cerium nitrate solution thereto, precipitating CeO₂ precursor onto the ZrO₂ precursor, and then firing it; and a method of hydrolyzing cerium alkoxide on ZrO₂ precursor or CeO₂ precursor, and then firing it.

In the case of providing a metal oxide support comprising multiple species of materials and using a combination of the properties thereof as described above, multiple species of metal oxide particles may be mixed but, if so mixed, a good combination of the properties of these metal oxides may not be attained, because the combined metal oxide particles each has a large size.

Also, a substantially uniform metal oxide particle may be obtained from a sol in which different species of colloid particles are mixed, but the uniform mixture does not always yield the best results.

For example, a composite metal oxide obtained by uniformly mixing ceria and zirconia is known to have good OSC and heat resistance, but sometimes does not allow ceria to satisfactorily bring out its property of preventing sintering of noble metal such as platinum. That is, the both of ceria and zirconia are present on the surface of this composite metal oxide and therefore, a part of the noble metal is supported on the zirconia portion rather than on the ceria portion, and cannot be prevented from sintering.

The present invention provides a metal oxide particle usable as a catalyst support comprising multiple species of metal oxides and capable of satisfactorily exerting the properties of respective metal oxides, and also provides a production process thereof and an exhaust gas purifying catalyst made of this metal oxide particle.

### DISCLOSURE OF INVENTION

The metal oxide particle of the present invention comprises a core part relatively rich in a first metal oxide and a surface layer relatively rich in a second metal oxide, the core part and the surface layer each comprising a plurality of primary particles, and the primary particle diameter of the second metal oxide being smaller than the primary particle diameter of the first metal oxide, particularly 70% or less, more particularly 50% or less, still more particularly 30% or less, of the primary particle diameter of the first metal oxide.

According to the metal oxide particle of the present invention, the composition is varied between the core part and the surface layer, whereby the properties of respective metal oxides can be combined. Also, the primary particle diameter of the second metal oxide mainly constituting the surface layer is smaller than the primary particle diameter of the first metal oxide mainly constituting the core part, and this is advantageous in that the particle surface is unfailingly covered with the second metal oxide. By such covering, when the metal oxide particle is used as a catalyst support, good interaction can be obtained between the catalyst metal supported and the second metal oxide.

The term “relatively rich in” as used herein for the metal oxide particle comprising a core part and a surface layer is used with respect to the molar fraction based on the total molar number of metals in each of the core part and the surface layer. Accordingly, for example, the “core part relatively rich in a first metal oxide” means that the molar fraction of a metal of the first metal oxide in the core part is higher than the molar fraction of this metal in the surface layer.

In one embodiment of the metal oxide particle of the present invention, the first metal oxide is zirconia and the second metal oxide is ceria.

According to this metal oxide particle, heat resistance is provided by zirconia in the core part, and when a noble metal such as platinum is supported on this metal oxide particle, sintering of the noble metal can be prevented by virtue of ceria in the surface layer.

In this metal oxide particle, the total molar fraction of cerium and zirconium may be at least 85 mol %, particularly at least 90 mol %, more particularly at least 95 mol %, based on the total molar number of metals in the metal oxide particle.

In one embodiment of the metal oxide particle comprising ceria and zirconia of the present invention, the metal oxide particle has a particle diameter of 2.3 to 8.1 μm.

This is preferred in the light of performance of an exhaust gas purifying catalyst obtained by loading a noble metal on the metal oxide particle.

In another embodiment of the metal oxide particle comprising ceria and zirconia of the present invention, the primary particle diameter of zirconia constituting the core part is 100 nm or less.

This is preferred in the light of performance of an exhaust gas purifying catalyst obtained by loading a noble metal on the metal oxide particle.

The exhaust gas purifying catalyst of the present invention is obtained by loading a noble metal, particularly platinum, on the above-described metal oxide particle comprising ceria and zirconia of the present invention.

According to this exhaust gas purifying catalyst, sintering of noble metal can be prevented by virtue of affinity of ceria for noble metal, and good catalyst performance can be provided.

The production process of a metal oxide particle of the present invention comprises providing a sol containing at least a population of first metal oxide colloid particles and a population of second metal oxide colloid particles differing in the isoelectric point with each other, the particle diameter of the population of second metal oxide colloid particles being smaller than the particle diameter of the population of first metal oxide colloid particles, particularly 70% or less, more particularly 50% or less, still more particularly 30% or less, of the particle diameter of the population of first metal oxide colloid particles; adjusting the pH of the sol to be closer to the isoelectric point of the population of first metal oxide colloid particles than to the isoelectric point of the population of second metal oxide colloid particles, particularly into the range of ±1.0, more particularly ±0.5, of the isoelectric point of the population of first metal oxide colloid particles, thereby aggregating the population of first metal oxide colloid particles; adjusting the pH of the sol to be closer to the isoelectric point of the population of second metal oxide colloid particles than to the isoelectric point of the population of first metal oxide colloid particles, thereby aggregating the population of second metal oxide colloid particles onto the population of first metal oxide colloid particles aggregated; and drying and firing the obtained aggregate.

According to the process of the present invention, a metal oxide particle comprising a core part relatively rich in a first metal oxide and a surface layer relatively rich in a second metal oxide can be obtained, in which the core part and the surface layer each comprises a plurality of primary particles, and the primary particle diameter of the second metal oxide is smaller than the primary particle diameter of the first metal oxide.

The term “colloid particles” as used herein means particles which comprise a metal oxide or a metal bonded to oxygen dispersed in a liquid, particularly water, and which produces a metal oxide when the dispersion medium is removed and the residue is fired. The “colloid particles” are generally understood to have a diameter of 1 to 1,000 nm, particularly from 1 to 500 nm. For example, colloid particles having a diameter of less than 100 nm or less than 50 nm is available.

The term “sol” as used herein means a dispersion system wherein colloid particles are dispersed in a dispersion medium which is a liquid, and this is sometimes referred to as a colloid solution. The dispersion medium contained in the sol is generally water, but an organic dispersion medium such as alcohol and acetylacetone may be contained, if desired.

### BRIEF DESCRIPTION OF THE DRAWINGS

FIG. 1 is a cross-sectional view showing the metal oxide particle of the present invention.

### BEST MODE FOR CARRYING OUT THE INVENTION

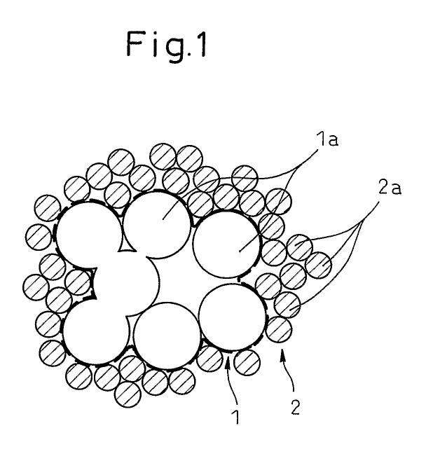

The present invention is described below by referring to FIG. 1. FIG. 1 is a cross-sectional view of the metal oxide particle of the present invention.

As shown in FIG. 1, the metal oxide particle of the present invention comprises a core part 1 (portion enclosed by the dotted line) relatively rich in a first metal oxide such as zirconia, and a surface layer 2 (portion outside the dotted line) relatively rich in a second metal oxide such as ceria. The core part and the surface layer each comprises a plurality of primary particles (1a, 2a).

In the case of producing the metal oxide particle of the present invention from a sol, the plurality of primary particles constituting each of the core part and the surface layer correspond to the colloid particles in the sol, and a distinct boundary may or may not be present between respective primary particles. Also, the boundary between the core part 1 and the surface layer 2 may not be necessarily distinct, and may appear as a portion where the composition is gradually changing. Furthermore, the boundary part between the core part 1 and the surface layer 2 may be a mixture, particularly a solid solution, of a first metal oxide and a second metal oxide. In FIG. 1, the surface layer 2 is shown as if it is discontinuous, but the surface layer may be substantially continuous.

As for the metal oxides constituting the metal oxide particle of the present invention, any metal oxide can be selected, and a metal oxide which is preferably held in the core part of the metal oxide particle may be selected as a first metal oxide, while selecting, as a second metal oxide, a metal oxide which is preferably exposed to the surface of the metal oxide particle. For example, the first metal oxide is preferably zirconia and the second metal oxide is preferably ceria. The zirconia has high heat resistance and the ceria can prevent sintering of platinum when platinum is supported therein.

When the surface layer or core part of the metal oxide particle of the present invention contains zirconia, ceria and/or ceria-zirconia solid solution, the core or surface layer may contain a metal other than cerium (Ce) and zirconium (Zr), for example, a metal selected from the group consisting of alkaline earth metals and rare earth elements, particularly yttrium (Y). These alkaline earth metals and rare earth elements, particularly yttrium, tend to provide excellent heat resistance to a zirconia, a ceria and/or a ceria-zirconia solid solution.

The exhaust gas purifying catalyst of the present invention can be produced by loading a noble metal such as platinum, rhodium and palladium, particularly platinum, on the metal oxide particle of the present invention. The noble metal may be loaded on the metal oxide particle by any known method but, for example, a method of impregnating the metal oxide particle with a solution containing a salt and/or a complex salt of noble metal, and drying and then firing it may be employed. The amount of the noble metal supported on the metal oxide particle may be from 0.01 to 5 mass %, particularly from 0.1 to 2 mass %, based on the metal oxide particle.

The exhaust gas purifying catalyst of the present invention may be used not only by shaping the catalyst itself but also by coating it on a monolith substrate, for example, a ceramic honeycomb.

The metal oxide particle of the present invention may be produced by any method but can be produced particularly by the process of the present invention.

Respective steps in the process of the present invention are described below.

<Provision of Sol Mixture>

In the process of the present invention, a sol comprising at least a population of first metal oxide colloid particles and a population of second metal oxide colloid particles differing in the isoelectric point with each other is provided, in which the particle diameter of the population of second metal oxide colloid particles is smaller than the particle diameter of the population of first metal oxide colloid particles.

Specific examples of the sol include substances obtained by hydrolyzing and condensing an alkoxide, an acetylacetonate, an acetate or a nitrate of metal. In addition, sols such as alumina sol, zirconia sol, titania sol and ceria sol are known materials and may also be available as commercial products.

The metal oxide sol generally available on the market has a pH different from the isoelectric point of the colloid particles contained therein, so that the colloid particles can electrostatically repel each other to prevent aggregation. That is, a sol containing colloid particles having an isoelectric point on the alkali side is stabilized by acidifying the sol (acid-stabilized sol), and a sol containing colloid particles having an isoelectric point on the acidic side is stabilized by alkalifying the sol (alkali-stabilized sol).

The isoelectric point of a population of colloid particles is not limited by a material itself constituting the particle, such as oxide, but can be arbitrarily set by the surface modification of colloid particles, particularly by the surface modification of colloid particles with an organic compound. Accordingly, a population of first metal oxide particles, and a population of second metal oxide colloid particles, for use in the process of the present invention, each may be arbitrarily selected to have an appropriate pH for the present invention. For example, these populations of colloid particles can be selected to give a difference of at least 3 or more, particularly 4 or more, more particularly 5 or more, between the isoelectric points of the populations of colloid particles.

The isoelectric point of a population of colloid particles, which must be known for the process of the present invention, may be determined by any method. For example, the isoelectric point can be measured by an electrophoretic light scattering method.

The sol containing at least two populations of colloid particles, which can be used in the process of the present invention, may be obtained by any method but, in particular, the sol can be obtained by mixing different sols. The mixing ratio of these populations of colloid particles can be arbitrarily determined depending on the desired properties of the metal oxide particle.

In the process of the present invention, an element such as an alkaline earth metal and a rare earth, which is preferably contained in the metal oxide particle, can be contained in the sol not only as a colloid particles but also as a metal salt such as a nitrate.

<Aggregation of First Metal Oxide Colloid particles>

In the process of the present invention, the pH of the sol is then adjusted to be closer to the isoelectric point of the population of first metal oxide colloid particles than to the isoelectric point of the population of second metal oxide colloid particles, thereby aggregating the population of first metal oxide colloid particles.

As described above, the metal oxide sol generally available on the market has a pH different from the isoelectric point of colloid particles contained therein, so that the colloid particles can electrostatically repel each other to prevent aggregation.

Accordingly, when the pH of a sol containing a population of first metal oxide colloid particles and a population of second metal oxide colloid particles is changed to the vicinity of the isoelectric point of the population of first metal oxide colloid particles, for example into the range of ±1.0, particularly ±0.5, of the isoelectric point of the population of first metal oxide colloid particles as in the present invention, the zeta potential of the population of first metal oxide colloid particles becomes small and this allows for little generation of electrical repulsion between the particles, whereby aggregation of the population of first metal oxide colloid particles is accelerated. In this stage, the pH of the sol is relatively different from the isoelectric point of the population of second metal oxide colloid particles and, therefore, the population of second metal oxide colloid particles has a relatively large zeta potential and is prevented from aggregation.

Incidentally, in aggregating the population of colloid particles, if the pH of the sol is changed to pass though the isoelectric point of the population of colloid particles intended to be aggregated, the zeta potential of this population of colloid particles becomes zero when the pH of the sol passes through the isoelectric point thereof, so that aggregation of this population of colloid particles can be unfailingly attained.

The pH of the sol can be adjusted by adding any acid or alkali. Examples of the acid which can be used include mineral acids such as nitric acid and hydrochloric acid, and examples of the alkali which can be used include aqueous ammonia and sodium hydroxide. The pH of the sol can also be adjusted by merely mixing multiple species of sols.

The pH of the sol can be adjusted by a method of adding an acid or an alkali to the sol while measuring the pH of the sol by a pH meter, or a method of predetermining the amount of acid or alkali necessary for the pH adjustment by using a previously sampled sol, and adding an acid or alkali to the entire sol in the predetermined amount.

<Aggregation of Second Metal Oxide Colloid Particles>

In the process of the present invention, the pH of the sol is then adjusted to be closer to the isoelectric point of the population of second metal oxide colloid particles than to the isoelectric point of the population of first metal oxide colloid particles, thereby aggregating the population of second metal oxide colloid particles onto the periphery of the population of first metal oxide colloid particles aggregated.

When the pH of the sol containing the population of first metal oxide colloid particles aggregated is changed to the vicinity of the isoelectric point of the population of second metal oxide colloid particles, the zeta potential of the population of second metal oxide colloid particles becomes small and this allows for little generation of electrical repulsion between the particles, whereby aggregation of the population of second metal oxide colloid particles is accelerated. In this stage, the pH of the sol is relatively different from the isoelectric point of the population of first metal oxide colloid particles, so that the population of first metal oxide colloid particles can be prevented from aggregation and the population of second metal oxide colloid particles can deposit onto the periphery of the population of first metal oxide colloid particles.

The pH of the sol can be adjusted in the same manner as in the above-described aggregation of the population of first metal oxide colloid particles.

<Drying and Firing of Aggregate>

In the process of the present invention, the thus-obtained aggregate is dried and fired, whereby a metal oxide particle is produced.

This metal oxide particle comprises a core part relatively rich in a first metal oxide and a surface layer relatively rich in a second metal oxide, in which the core part and the surface layer each comprises a plurality of primary particles, and the primary particle diameter of the second metal oxide mainly constituting the surface layer is smaller than the primary particle diameter of the first metal oxide mainly constituting the core part.

The removal and drying of dispersion medium from sol may be performed by any method at any temperature. For example, this can be achieved by placing the sol in an oven at 120° C. The material obtained by removing and drying the dispersion medium from the sol is fired, whereby the metal oxide particle can be obtained. The firing may be performed at a temperature generally employed for producing metal oxides, for example, at a temperature of 500 to 1,100° C.

The present invention is described in greater detail below by referring to Examples, but the present invention is not limited thereto.

### EXAMPLES

In the following tests, the pH of the sol was measured by using a pH meter wherein the pH meter electrode was directly dipped in the sol. The particle diameter of the population of colloid particles in the sol was measured by a dynamic light scattering method (photon correlation method) using a Model N4 manufactured by Beckman Coulter, Inc. Also, the particle diameter of the obtained metal oxide (secondary particles) was measured by using a laser diffraction/scattering particle size distribution measuring device manufactured by Horiba Ltd.

### Examples 1

In this Example, a metal oxide particle comprising a core part relatively rich in zirconia and a surface layer relatively rich in ceria (ceria (CeO₂):zirconia (ZrO₂): barium oxide (BaO)=58:38:4 (by weight)) is obtained, and platinum is supported on this metal oxide particle. The primary particle diameter of ceria mainly constituting the surface layer is 29 nm, the primary particle diameter of zirconia mainly constituting the core part is 47 nm, and the particle diameter of the metal oxide particle obtained is 5.8 μm.

Acid-stabilized ceria sol (116.0 g) (CeO₂ content: 15 wt %, Needral, produced by Taki Chemical Co., Ltd., colloid particle diameter: 29 nm, isoelectric point: pH 8.5), 111.7 g of an alkali-stabilized zirconia sol (ZrO₂ content: 10.2 wt %, produced by Taki Chemical Co., Ltd., colloid particle diameter: 47 nm, at isoelectric point: pH 3.5), and 1.9 g of barium nitrate were mixed, thereby rendering the mixed sol acidic and aggregating zirconia.

Thereafter, an aqueous ammonia (NH₃) solution was added dropwise to this sol mixture with stirring to adjust the pH to 10, thereby aggregating ceria. The resulting solution was dried at 120° C. for 24 hours, and the dried product was fired at 700° C. for 5 hours. The obtained metal oxide particle was measured by XRD, as a result, respective peaks of zirconia and ceria were independently obtained.

Subsequently, 15 g of the thus-obtained metal oxide particles were dispersed in 150 g of water, 3.41 g of a dinitrodiammine Pt solution (platinum content: 4.4 wt %) was added thereto so that platinum is in an amount of 1.0 wt % based on the metal oxide particle, and the resulting solution was stirred for 2 hours. Thereafter, the water content was removed by drying at 120° C., the residue was fired at 500° C. for 2 hours, and the obtained catalyst was shaped into a 1 mm-square pellet and used for the evaluation of performance.

### Example 2

In this Example, a metal oxide particle comprising a core part relatively rich in zirconia and a surface layer relatively rich in ceria (ceria:zirconia:barium oxide=58:38:4 (by weight)) is obtained, and platinum is supported on this metal oxide particle. The primary particle diameter of ceria mainly constituting the surface layer is 29 nm, the primary particle diameter of zirconia mainly constituting the core part is 95 nm, and the particle diameter of the metal oxide particle obtained is 8.1 μm.

A catalyst was obtained in the same manner as in Example 1 except for using, as raw materials, 116.0 g of an acid-stabilized ceria sol (CeO₂ content: 15 wt %, Needral, produced by Taki Chemical Co., Ltd., colloid particle diameter: 29 nm), 97.4 g of an alkali-stabilized zirconia sol (ZrO₂ content: 11.7 wt %, colloid particle diameter: 95 nm), and 1.9 g of barium nitrate.

### Example 3

In this Example, a metal oxide particle comprising a core part relatively rich in zirconia and a surface layer relatively rich in ceria (ceria:zirconia:barium oxide=58:38:4 (by weight)) is obtained, and platinum is supported on this metal oxide particle. The primary particle diameter of ceria mainly constituting the surface layer is 5 nm, the primary particle diameter of zirconia mainly constituting the core part is 47 nm, and the particle diameter of the metal oxide particle obtained is 5.4 μm.

A catalyst was obtained in the same manner as in Example 1 except for using, as raw materials, 114.4 g of an acid-stabilized ceria sol (CeO₂ content: 15.2 wt %, produced by Nissei Corp., colloid particle diameter: 5 nm), 111.7 g of an alkali-stabilized zirconia sol (ZrO₂ content: 10.2 wt %, Ecolite, produced by Taki Chemical Co., Ltd., colloid particle diameter: 47 nm), and 1.9 g of barium nitrate.

### Example 4

In this Example, a metal oxide particle comprising a core part relatively rich in zirconia and a surface layer relatively rich in ceria (ceria:zirconia:barium oxide=58:38:4 (by weight)) is obtained, and platinum is supported on this metal oxide particle. The primary particle diameter of ceria mainly constituting the surface layer is 5 nm, the primary particle diameter of zirconia mainly constituting the core part is 32 nm, and the particle diameter of the metal oxide particle obtained is 2.3 μm.

A catalyst was obtained in the same manner as in Example 1 except for using, as raw materials, 114.4 g of an acid-stabilized ceria sol (CeO₂ content: 15.2 wt %, produced by Nissei Corp., colloid particle diameter: 5 nm), 106.5 g of an alkali-stabilized zirconia sol (ZrO₂ content: 10.7 wt %, colloid particle diameter: 32 nm), and 1.9 g of barium nitrate.

### Example 5

In this Example, a metal oxide particle comprising a core part relatively rich in zirconia and a surface layer relatively rich in ceria (ceria:zirconia:barium oxide=58:38:4 (by weight)) is obtained, and platinum is supported on this metal oxide particle. The primary particle diameter of ceria mainly constituting the surface layer is 29 nm, the primary particle diameter of zirconia mainly constituting the core part is 153 nm, and the particle diameter of the metal oxide particle obtained is 9.5 μm.

A catalyst was obtained in the same manner as in Example 1 except for using, as raw materials, 116.0 g of an acid-stabilized ceria sol (CeO₂ content: 15 wt %, Needral, produced by Taki Chemical Co., Ltd., colloid particle diameter: 29 nm), 105.6 g of an alkali-stabilized zirconia sol (ZrO₂ content: 10.8 wt %, produced by Dowa Mining Co., Ltd., colloid particle diameter: 153 nm), and 1.9 g of barium nitrate.

### Example 6

In this Example, a metal oxide particle comprising a core part relatively rich in zirconia and a surface layer relatively rich in ceria (ceria:zirconia:barium oxide=58:38:4 (by weight)) is obtained, and platinum is supported on this metal oxide particle. The primary particle diameter of ceria mainly constituting the surface layer is 5 nm, the primary particle diameter of zirconia mainly constituting the core part is 24 nm, and the particle diameter of the metal oxide particle obtained is 1.1 μm.

A catalyst was obtained in the same manner as in Example 1 except for using, as raw materials, 114.4 g of an acid-stabilized ceria sol (CeO₂ content: 15.2 wt %, produced by Nissei Corp., colloid particle diameter: 5 nm), 186.9 g of an alkali-stabilized zirconia sol (ZrO₂ content: 6.1 wt %, colloid particle diameter: 24 nm), and 1.9 g of barium nitrate.

### Comparative Example 1

In this Comparative Example, a ceria particle is obtained as the metal oxide particle and platinum is supported on the ceria particle.

Cerium ammonium nitrate (80.0 g) was added to 500 g of water, and an aqueous ammonia solution was added dropwise thereto to adjust the pH to 9 and cause precipitation. The resulting solution was dried at 120° C. for 24 hours, and the dried product was fired at 700° C. for 5 hours. On the thus-obtained metal oxide particle, 1.0 wt % of platinum was supported in the same manner as in Example 1. The catalyst obtained was shaped into a 1 mm-square pellet and used for the evaluation of performance.

### Comparative Example 2

In this Comparative Example, a ceria-zirconia-barium oxide solid solution particle (ceria:zirconia:barium oxide=58:38:4 (by weight)) is obtained as the metal oxide particle, and platinum is supported on the solid solution particle.

Cerium ammonium nitrate (73.89 g), 32.96 g of zirconium oxynitrate dihydrate and 2.53 g of barium nitrate were added to 500 g of water and uniformly stirred, and an aqueous ammonia solution was added dropwise thereto to adjust the pH to 9 and cause precipitation. The resulting solution was dried at 120° C. for 24 hours, and the dried product was fired at 700° C. for 5 hours. On the thus-obtained metal oxide particle, 1.0 wt % of platinum was supported in the same manner as in Example 1. The catalyst obtained was shaped into a 1 mm-square pellet and used for the evaluation of performance.

### Comparative Example 3

In this Comparative Example, a metal oxide particle comprising a core part relatively rich in zirconia and a surface layer relatively rich in ceria (ceria:zirconia:barium oxide=58:38:4 (by weight)) is obtained, and platinum is supported on this metal oxide particle. The primary particle diameter of ceria mainly constituting the surface layer is 87 nm, the primary particle diameter of zirconia mainly constituting the core part is 47 nm, and the particle diameter of the metal oxide particle is 10.2 μm.

A catalyst was obtained in the same manner as in Example 1 except for using, as raw materials, 303 ml of an acid-stabilized ceria sol (colloid particle diameter: 87 nm), 67.1 g of an alkali-stabilized zirconia sol (ZrO₂ content: 10.2 wt %, Ecolite, produced by Taki Chemical Co., Ltd., colloid particle diameter: 47 nm), and 1.22 g of barium nitrate. The acid-stabilized ceria sol used here was obtained by dissolving 40 g of cerium ammonium nitrate in 365 ml of distilled water and aging the resulting solution in a pressure vessel at 120° C. for 24 hours.

<Evaluation of Catalyst Performance>

The pellet-like catalysts obtained in Examples 1 to 6 and Comparative Examples 1 to 3 were subjected to the rich and lean gases shown in Table 1. The guses each passed therethrough at a flow rate of 5 L/min at 1,000° C. for 5 hours and these gases were switched over every one minute. thereafter, rich and lean gases for the test shown in Table 2 were passed through 3 g of the catalyst each at a flow rate of 20 L/min (space velocity: about 200,000 h⁻¹) and these gases were switched over at 0.5 Hz. The gas temperature was elevated at a rate of 25° C./min to determine the temperature where the C₃H₆ purification ratio reached 50% (HC-T50). Also, the specific surface area (SSA) was measured by using a BET one-point method. Furthermore, the platinum particle diameter of catalyst was determined by a CO pulse adsorption method at =800° C. The results obtained are shown in Table 3.

TABLE 1
Composition of Gases for Endurance

| | N₂ | CO₂ | NO | CO | C₃H₆ | O₂ | H₂O |
|---|---|---|---|---|---|---|---|
| | (%) | (%) | (ppm) | (%) | (ppmC) | (%) | (%) |
| Rich Gas | balance | 14.38 | 4800 | 1.1 | 4800 | 0.3 | 10 |
| Lean Gas | balance | 14.38 | 1200 | 0.1 | 1200 | 1.1 | 10 |

TABLE 2
Composition of Gases for Test

| | N₂ | CO₂ | NO | CO | C₃H₆ | H₂ | O₂ | H₂O |
|---|---|---|---|---|---|---|---|---|
| | (%) | (%) | (ppm) | (%) | (ppmC) | (%) | (%) | (%) |
| Rich | Bal- | 10 | 2200 | 2.8 | 2500 | 0.27 | 0.77 | 10 |
| Gas | ance | | | | | | | |
| Lean | Bal- | 10 | 2200 | 0.81 | 2500 | 0 | 1.7 | 10 |
| Gas | ance | | | | | | | |

TABLE 3
Evaluation Results of Catalyst after Endurance

| | | | | Average | | |
|---|---|---|---|---|---|---|
| | | | | Secondary | | Pt |
| | Colloid Particle | | | Particle | | Particle |
| | diameter (nm) | | SSA | diameter | HC-T50 | diameter |
| | CeO₂ | ZrO₂ | (m²/g) | (μm) | (° C.) | (nm) |
| Ex. 1 | 29 | 47 | 32 | 5.8 | 260 | 9 |
| Ex. 2 | 29 | 95 | 25 | 8.1 | 273 | 11 |
| Ex. 3 | 5 | 47 | 42 | 5.4 | 251 | 7 |
| Ex. 4 | 5 | 32 | 31 | 2.3 | 263 | 9 |
| Ex. 5 | 29 | 153 | 21 | 9.5 | 311 | 26 |
| Ex. 6 | 5 | 24 | 34 | 1.1 | 298 | 16 |
| Comp. Ex. 1 | — | — | 7 | — | 301 | 19 |
| Comp. Ex. 2 | — | — | 31 | — | 298 | 17 |
| Comp. Ex. 3 | 87 | 47 | 26 | 10.2 | 303 | 23 |

As is apparent from Table 3, the support of Comparative Example 1 consisting of ceria particles is low in the heat resistance as compared with the supports of Examples 1 to 6 of the present invention and therefore, the specific surface area is small.

The support of Comparative Example 2 comprising a ceria-zirconia-barium oxide solid solution is improved in the heat resistance by virtue of the presence of zirconia as compared with the support of Comparative Example 1 consisting of ceria particles. However, when compared with the support of Example 4 having the same specific surface area, the particle diameter of platinum supported is large and accordingly, it should be understood that ceria cannot satisfactorily exert the ability of preventing sintering of platinum. This is considered to result because both ceria and zirconia are present on the surface of this solid solution and a part of platinum is supported on the zirconia portion rather than the ceria portion.

In the support of Comparative Example 3 having a shell (surface layer) and core structure but made of a population of relatively large ceria colloid particles and a population of relatively small zirconia colloid particles, the particle diameter of platinum supported is large as compared with the support of Example 2 having a similar specific surface area. Therefore, it is understood that the ability of preventing sintering of platinum is not satisfactorily exerted. This is considered to result because, in the support particle of Comparative Example 3, the particle surface is not fully covered with ceria due to large primary particle diameter of ceria.

Among the catalysts of Examples, those of Examples 1 to 4 where the primary particle diameter of zirconia is 100 μm or less and the average secondary diameter is from 2.3 to 8.1 μm are excellent in terms of HC-T50, that is, have high activity even at a relatively low temperature.

1. A catalyst support particle comprising a core part and a surface layer,
wherein the molar fraction of the metal constituting the first metal oxide in the core part is higher than the molar fraction of the metal constituting the first metal oxide in the surface layer;
wherein the molar fraction of the metal constituting the second metal oxide in the surface layer is higher than the molar fraction of the metal constituting the second metal oxide in the core part;
wherein the primary particle diameter of said second metal oxide is smaller than the primary particle diameter of said first metal oxide.

2. The catalyst support particle according to claim 1, wherein the first and second metal oxides are independently selected from the group consisting of alumina, zirconia, titania and ceria.

3. The catalyst support particle according to claim 2, wherein said first metal oxide is zirconia and said second metal oxide is ceria.

4. The catalyst support particle according to claim 3, wherein the catalyst support particle has a particle diameter of 2.3 to 8.1 μm.

5. The catalyst support particle according to claim 3, wherein the primary particle diameter of zirconia constituting said core part is 100 nm or less.

6. An exhaust gas purifying catalyst comprising a noble metal supported on the catalyst support particle according to claim 1.

7. A process for producing the catalyst support particle according to claim 1, comprising:
providing a sol containing at least a population of first metal oxide colloid particles and a population of second metal oxide colloid particles differing in the isoelectric point with each other, the particle diameter of said population of second metal oxide colloid particles being smaller than the particle diameter of said population of first metal oxide colloid particles,
adjusting the pH of said sol to be closer to the isoelectric point of said population of first metal oxide colloid particles than to the isoelectric point of said population of second metal oxide colloid particles, thereby aggregating said population of first metal oxide colloid particles,
adjusting the pH of said sol to be closer to the isoelectric point of said population of second metal oxide colloid particles than to the isoelectric point of said population of first metal oxide colloid particles, thereby aggregating said population of second metal oxide colloid particles onto said population of first metal oxide colloid particles aggregated, and
drying and firing the obtained aggregate.

8. The catalyst support particle according to claim 4, wherein the primary particle diameter of zirconia constituting said core part is 100 nm or less.

9. An exhaust gas purifying catalyst comprising a noble metal supported on the catalyst support particle according to claim 2.

10. An exhaust gas purifying catalyst comprising a noble metal supported on the catalyst support particle according to claim 3.

11. An exhaust gas purifying catalyst comprising a noble metal supported on the catalyst support particle according to claim 4.

12. An exhaust gas purifying catalyst comprising a noble metal supported on the catalyst support particle according to claim 5.

13. An exhaust gas purifying catalyst comprising a noble metal supported on the catalyst support particle according to claim 8.
